(19) United States
(12) Patent Application Publication
(10) Pub. No.: US 2010/0201075 A1
(43) Pub. Date: Aug. 12, 2010

(54) ISOLATOR SEALING DEVICE

(76) Inventors: Alan James Roddis, Sheffield (GB); Andrew Colverson, Doncaster (GB)

Correspondence Address: EDWIN D. SCHINDLER, FIVE HIRSCH AVENUE, P.O. BOX 966, CORAM, NY, 11727-0966, US

(21) Appl. No.: 12/679,797

(22) PCT Filed: Sep. 24, 2008
(86) PCT No.: PCT/GB08/03229

§ 371 Date: Mar. 24, 2010

(51) Int. Cl. F16J 15/32

(52) U.S. Cl. 277/402; 277/395

(57) ABSTRACT

An isolator sealing device includes a stator, which locates into a housing of a piece of rotating equipment, and a rotor which radially locates onto a rotary shaft of the piece of rotating equipment. The rotor and stator have one or more adjacent surfaces facing a labyrinth seal and a lip seal which sealingly engages the stator or the rotor when the equipment is idle and sealingly disengages the stator or the rotor when the equipment is operational.

### FIELD OF THE INVENTION

This invention relates to isolator sealing devices and particularly to non-contacting seals protectors and their use in rotating equipment. Such devices prevent the ingress or egress of a fluid or solid to a cavity, resulting in deterioration of equipment life.

Such devices are often referred to as bearing protectors, bearing seals or bearing isolators. However, seals of the present invention may be used for applications other than the protection of bearings. Accordingly, while reference below may be to bearing protectors, it should be understood that the invention may have wider uses.

### BACKGROUND TO THE INVENTION

The purpose of a bearing protector is to prevent the ingress of fluid, solids and/or debris from entering a bearing chamber. Equally, bearing protectors are employed to prevent the egress of fluid or solids from a bearing chamber. Essentially, their purpose is to prevent the premature failure of the bearing.

Bearing protectors generally fall into two categories: repeller or labyrinth bearing protectors; and mechanical seal bearing protectors. Reference is made to our co-pending labyrinth seal bearing protection application GB0415548.7 which defines a substantially non-contacting bearing protector with static shut off device.

The rotating component typically has a complex outer profile which is located adjacent and in close radial and axial proximity to a complex inner profile of the stationary component. Together these complex profiles, in theory, provide a tortuous path preventing the passage of the unwanted materials or fluids.

Conventional labyrinth technology indicates the said close radial counter rotational members are substantially parallel to each other and run parallel to the centreline of the shaft. Given that the fundamentals of the design is that the rotor and stator are non-contacting, it will not hold a level of bearing lubricant which is greater than the smallest radial position between the rotor and stator. Unfortunately, operators occasionally overfill bearing chambers with lubricant, meaning that in certain cases the lubricant runs out of the labyrinth seal and onto the surrounding work area.

Also, during installation, some types of rotating equipment are not perfectly aligned in the horizontal axis. Given that the bearing lubricant will always sit perfectly on the horizontal axis inside the bearing chamber, if the rotating equipment bearing chamber is misaligned to the horizontal axis, the bearing lubricant will be higher at one side of the bearing chamber than at the other side. Once again, this can cause the lubricant to run through the labyrinth clearances specifically when the equipment is in the static condition. When the equipment is in the dynamic condition, centrifugal forces and/or the complex geometries of the labyrinth and lubricant velocity reducing cavities can sufficiently discourage lubricant egress, even when the equipment is slightly misaligned.

Orlowski U.S. Pat. No. 6,234,489 teaches a bearing isolator with an integral lipseal with energising member, item 25, which apparently applies a radial force to the sealing member lip thereby helping to maintaining radial sealing contact a seal between the stationary lipseal and rotor member.

In essence, Orlowski U.S. Pat. No. 6,234,489 teaches a contacting bearing isolator, which gives rise to a whole host of additional issues compared a non-contacting isolator, such as high lipseal wear, high heat generation and increase equipment energy consumption.

A preferred non-contacting labyrinth-type seal bearing protector will effectively seal high lubricant levels, specifically when the equipment is static and is misaligned. Such a sealing device desirably also acts as a non-contacting device when the equipment is operational.

### STATEMENTS OF THE INVENTION

According to the present invention there is provided a non-contacting sealing device comprising a stator which is rotationally coupled to the housing of an item of rotating equipment and a rotor which is rotationally coupled to the rotor of an item of rotating equipment, said rotor and stator having one or more radial and/or axial adjacent surfaces forming a labyrinth seal, and a lip-type seal which sealingly engages the stator when the equipment is idle and sealingly disengages the stator when the equipment is operational.

Preferably, the device incorporates an external shut off device which provides a non-contacting seal when the equipment is operational and a contacting seal when the equipment is static, thereby preventing moisture ingress during equipment cool down periods.

Preferably the lip-type sealing member sealingly engages the stator on a substantially male cylindrical portion of said stator.

Preferably, the lip-type seal includes a lip which is structured for sealing engagement when the equipment is stationary and for disengagement at low rotational speeds.

Preferably, a second sealing device, termed a shut-off valve, is positioned on the atmospheric side of the device, said shut-off valve engaging the stator or rotor when the equipment is idle and sealingly disengaging the stator or rotor when the equipment is operational. The shut-off valve may include a solid toroidal member.

Preferably, the device includes at least one deformable toroidal member providing sealing between the equipment housing the stator.

Preferably, the device includes at least one deformable torroidal member providing sealing between the equipment shaft the rotor.

Preferably, the lipseal comprises a body portion abutting the radially inner surface of a longitudinal flange of the rotor.

Preferably the lip of the lipseal extends radially inwardly from said body portion into engagement, when the equipment is stationary, with a longitudinal flange of the stator.

Preferably, the lip has a first portion extending from the body portion of the lipseal towards the flange of the stator and a second portion extending from said first portion to a position between the flange of the stator and said body portion.

Preferably, the lipseal is of substantially V-shaped cross-section.

Preferably, the second portion is provided with an enlarged end portion.

Preferably, the lip is integral with and made of the same material as that of the main part of the body portion. Also preferred is an arrangement in which the lip is formed of at least two parts, a first part being integral with and made of the same material as that of the main part of the body portion and a second part being formed of a denser material. More preferably, the denser material is a metal band.

In a device of the present invention, the lipseal acts, under static conditions, as a normal lipseal, that is to say, providing a sealing function. Under the dynamic conditions, the lip lifts, that is to say, the seal disengages, thereby reducing wear on the lip of the lipseal.

When a device of the invention incorporates both a lipseal and a mechanical shut off valve. The latter only prevents so-called chamber breathing. A flooded environment may be created at one or both ends of a bearing, for example, during transit of the equipment when it is not transported in a horizontal condition. The lipseal provides sealing against escape of oil which might cause premature failure of the bearing.

Embodiments of labyrinth seals in accordance with the present invention may be in substantially cartridgised form whereby the rotor and stator are longitudinally coupled, or substantially non-cartridgised.

Furthermore, in a preferred embodiment the labyrinth seal stator is provided with a substantially radial cavity adjacent to the rotor and/or equipment shaft. The radial cavity is discontinued at the 6 o'clock position (viewing from a longitudinal end) permitting any lubricant/oil gathered in the cavity to drain back into the equipment bearing chamber.

Preferably, the stator has a sealing member to sealingly engage the stator of the rotating equipment.

Preferably, the rotor has a sealing member to sealingly engage the rotor of the rotating equipment.

### DESCRIPTION OF THE DRAWINGS

The accompanying drawings are as follows:

FIG. 1 is a partial longitudinal section of a first embodiment of a labyrinth seal bearing protector of the invention mounted on a shaft;

FIG. 2 is a partial longitudinal section of a second embodiment of a labyrinth seal bearing protector of the invention mounted on a shaft.

FIG. 3 is a partial longitudinal section of a third embodiment of a bearing protector of the invention mounted on a shaft;

FIG. 4 is a partial longitudinal section of fourth embodiment of a labyrinth seal bearing protector of the invention mounted on a shaft;

FIG. 5 is a partial longitudinal section of a fifth embodiment of a labyrinth seal bearing protector on the invention mounted on a shaft;

FIG. 6 is a partial longitudinal section of a sixth embodiment of a labyrinth seal bearing protection of the invention mounted on a shaft; and

FIG. 7 is a partial longitudinal section of the seventh embodiment of a labyrinth seal bearing protector of the invention mounted on a shaft

### DETAILED DESCRIPTION OF THE INVENTION

The invention will now be described, by way of example only, with reference to the accompanying drawings.

In general, rotary seals in accordance with the present invention may be used not only in the case where the shaft is a rotary member and the housing is a stationary member but also the reverse situation, that is to say, in which the shaft is stationary and the housing is rotary.

Furthermore, the invention may be embodied in both rotary and stationary arrangements, cartridge and component seals with metallic components as well as non-metallic components.

Furthermore, the invention may be embodied when the rotary and/or the stationary are circumferentially solid, or when either or both of the members are radially split.

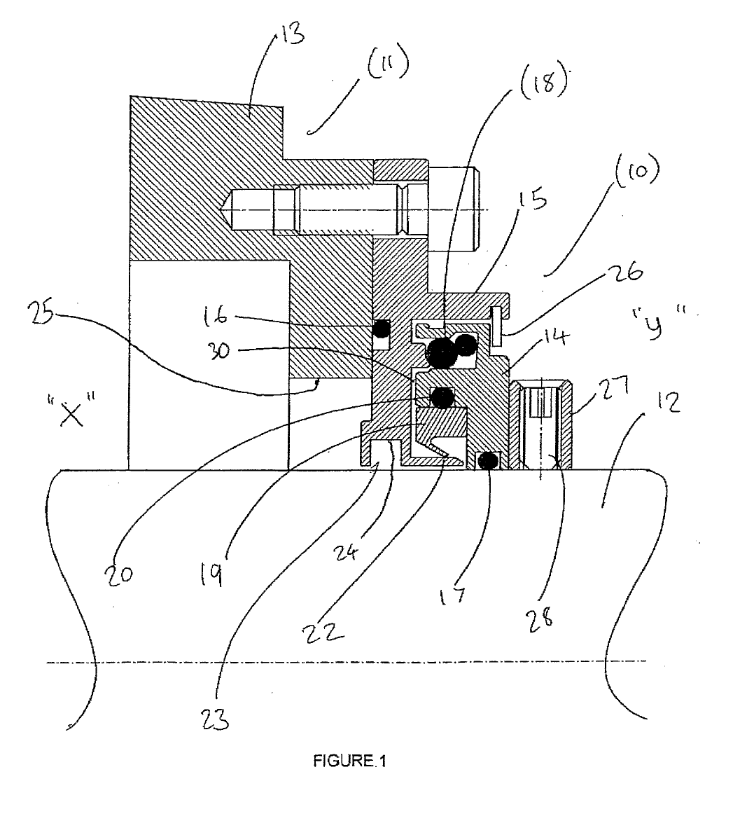

Referring to FIG. 1 of the accompanying drawings, a first embodiment of the invention is a bearing protector assembly 10 which is fitted to an item of rotating equipment 11. The equipment includes a rotating shaft 12 and a stationary housing 13. The stationary housing 13 could typically contain a bearing, which is not illustrated.

Area “X” at one axial end of the bearing protector assembly 10 could partially contain fluid and/or solids and/or foreign debris and/or atmosphere. However for clarity it will herein be termed “product substance”, being used to describe a single or mixed medium.

Area “Y” at the other axial end of the bearing protector assembly 10 could also partially contain fluid and/or solids and/or foreign debris and/or atmosphere. However, for clarity it will herein be termed “atmospheric substance”, being used to describe a single or mixed medium.

The bearing protector assembly 10 includes a rotor member 14, which is radially and axially adjacent to stator member 15.

A housing elastomer 16 provides a radial seal between the housing 13 and stator 15. A shaft elastomer 17 provides a radial seal between the shaft 12 and rotor 14.

A static shut off device 18 is described in our co-pending labyrinth seal bearing protection application GB0415548.7 and will not be further described.

A lip-type seal 19 is radially positioned in a cavity of the rotor 14 and is sealingly engaged to said rotor 14 by elastomer 20.

Said lip-type seal 19 preferably sealingly engages the stator 15 on a substantially cylindrical surface 22.

Stator 15 has a radially extending cavity 23 positioned adjacent to the rotating member of either the equipment (shaft 12) or rotor 14. Said stator circumferential surface is discontinued at the 6 o'clock position, viewed from the end, whereby the innermost surfaces 24 of the radial groove 23 communicate with the innermost sections of the equipment bearing chamber 25.

Preferably, the rotor 14 is longitudinally coupled to said stator 15 by face shield 26, thereby cartridgising the assembly for ease of installation purposes.

Shown, for reference only, is an optional drive ring collar 27, which permits the rotor members of the labyrinth seal 10 to be positively driven by one or more screw members 28 to the shaft 12. The drive collar 27 also prevents the rotor from “walking” longitudinally down the shaft in equipment vibration conditions.

In the event that the equipment is idle, the shut off valve 18 prevents moisture being sucked from the atmospheric side “Y” of the bearing chamber into the seal cavity 30.

Furthermore, in the event that the equipment is idle, the lip-type seal 19 prevents bearing lubricant, namely oil, from being displaced into said cavity 30 and/or to atmosphere, in lubricant overfill or equipment misaligned conditions.

When the equipment is operational, because the lip-type 19 sealing member is rotational and coupled with the rotor 14, it is subject to centrifugal forces. Said centrifugal forces act to throw the lip-type seal 19 radially outwardly and away from sealing engagement at area 22 with the stator.

Preferably, this creates a non-contacting seal at area 22. However, equally preferably it reduces the sealing forces imparted by the lip-type seal 19 on the stator 15 therefore extending the sealing ability of said lip-type seal and reducing equipment power consumption.

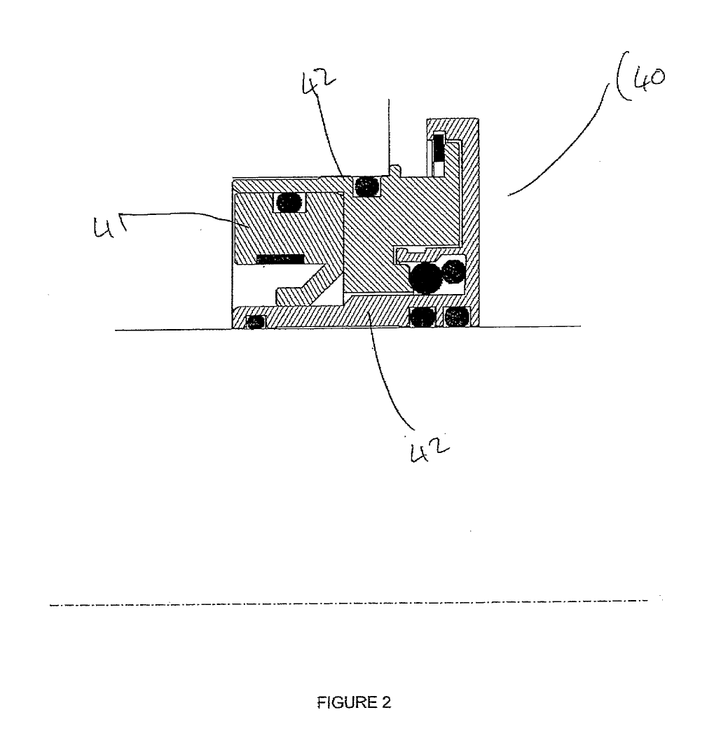

FIG. 2 shows an alternative embodiment of the invention 40, showing the lip-type seal 41 rotationally coupled to the stator member 42 with a radial sealing interface on a substantially cylindrical portion of the rotor 43.

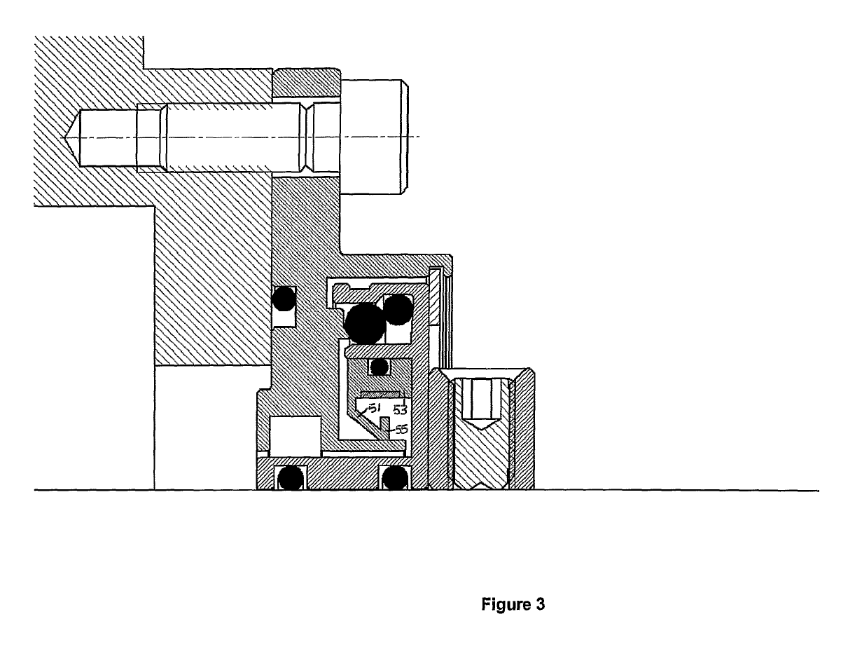

FIGS. 3 to 7 illustrate variations of the embodiment shown in FIG. 1. In the FIG. 3 embodiment, the lip 51 of lipseal 53 differs from the embodiment shown in FIG. 1 in that, instead of a simple angled flange, the lip includes a radially outwardly extending end portion 55. This adds mass to the end of the lip and promotes its lift from the sealing position shown in FIG. 3 when the equipment is rotating.

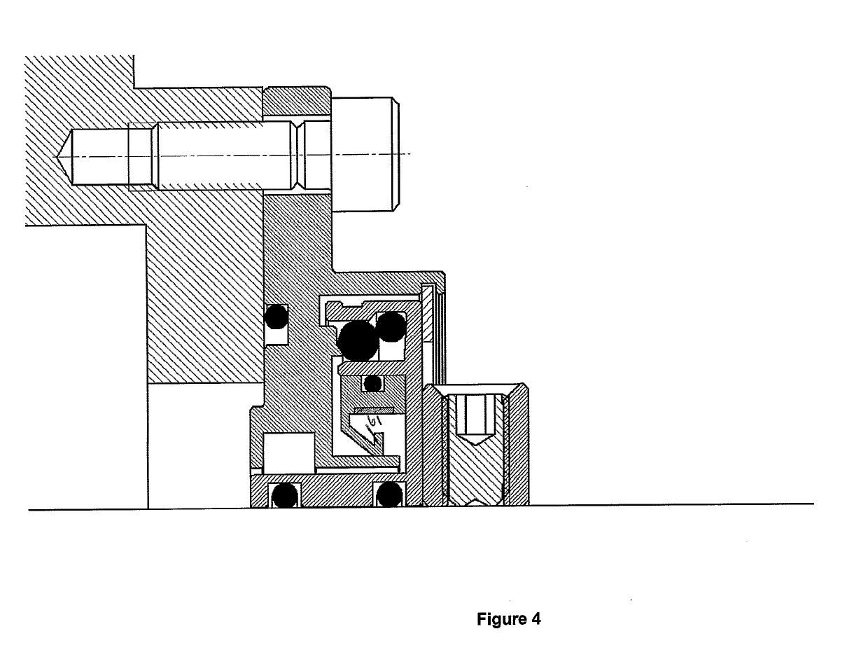

In the embodiment shown in FIG. 4, the lip extension 61 is angled as illustrated and is longer than the extension in FIG. 3 thereby further enhancing the lift capabilities.

By way of example the lips in the above described embodiments may be made of a PTFE composite material. Alternatively the lips may be segmented, with two or more materials allowing a relatively dense material to be provided such as to enhance lift.

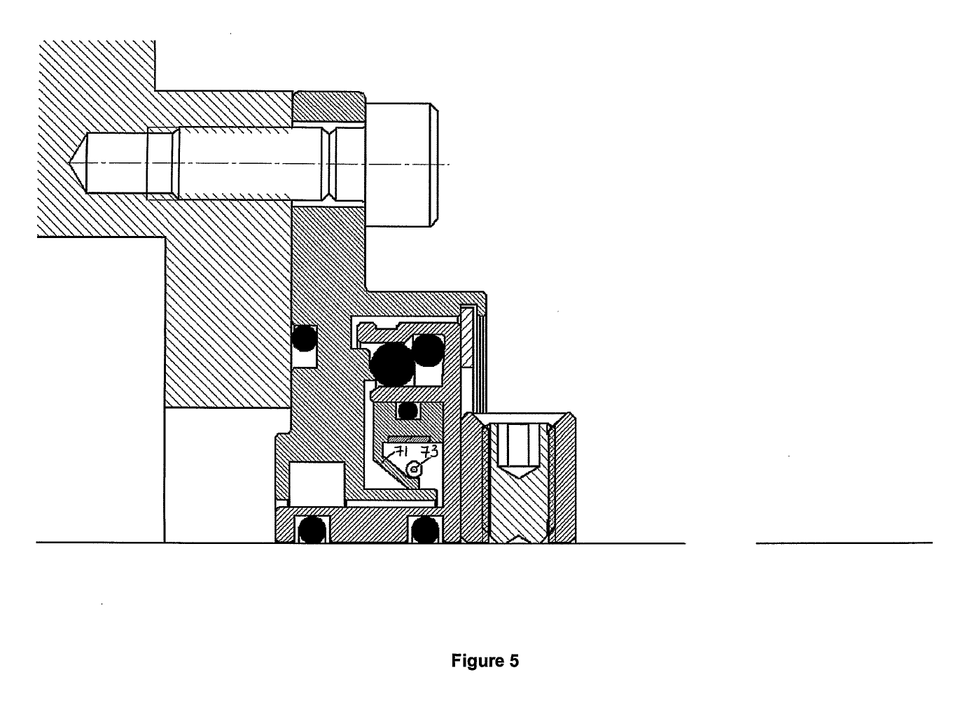

Referring to FIG. 5, the lip 71 is similar to that of the FIG. 3 embodiment except that the radial extension is replaced by a metal ring 73 (or a spring) which again acts to increase the mass of the end of the lip, thereby promoting lift when the equipment is rotating.

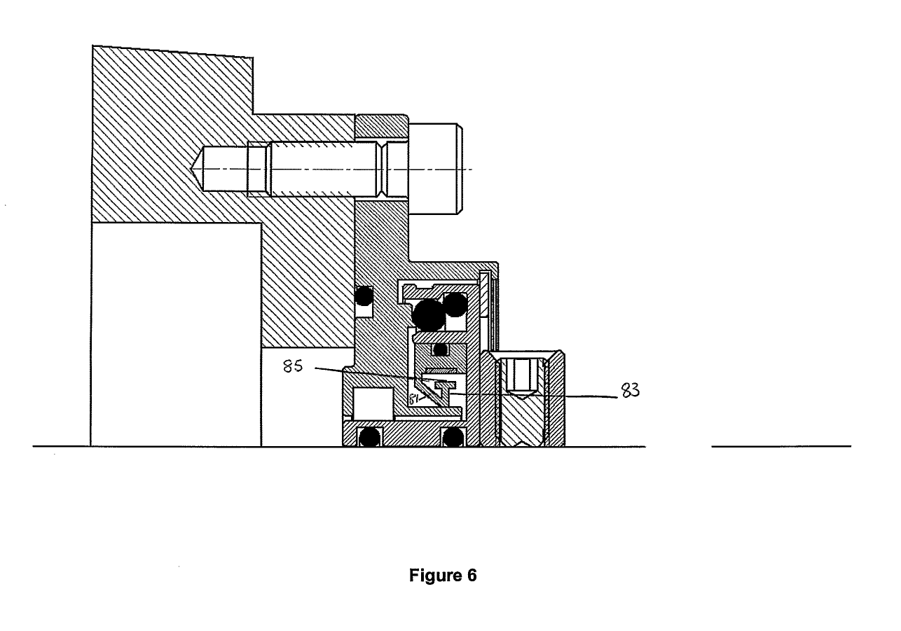

Referring to FIG. 6, the lip 81 is similar to that of the FIG. 3 embodiment except that the radial extension 83 is provided with an enlarged end 85, providing a longitudinal flange.

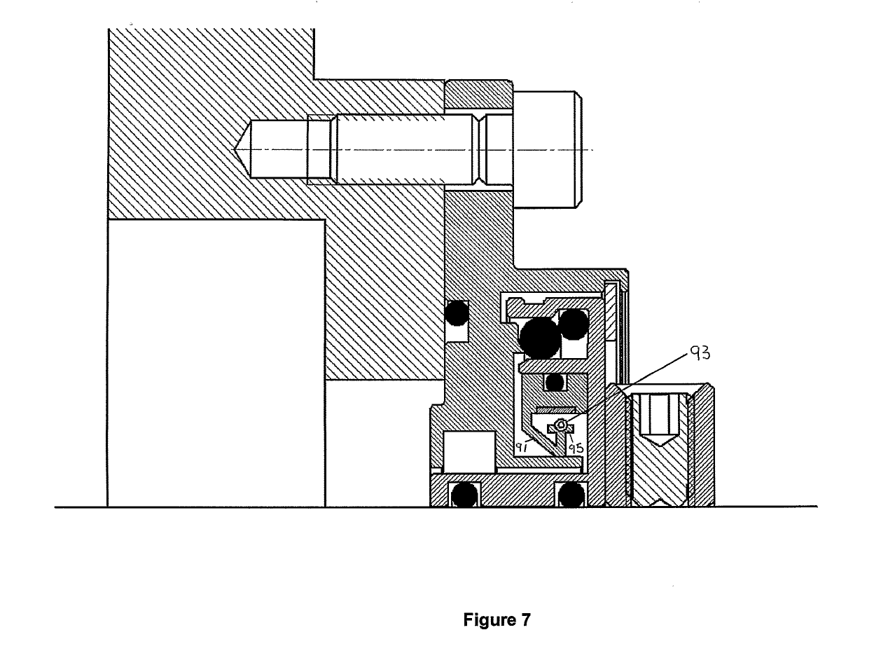

Referring to FIG. 7, the lip 91 is similar to that of FIG. 6 except that a metal ring or spring 93 is secured to the enlarged end 95.

1-14. (canceled)

15. An isolator sealing device, comprising:
a stator locatable into a housing of a piece of equipment;
a rotor radially locatable onto a rotary shaft of the piece of equipment, said rotor and said stator have at least one adjacent surface facing a labyrinth seal; and,
a lip seal sealingly engaging said stator or said rotor when the piece of equipment is idle and sealingly disengaging said stator or said rotor when the piece of equipment is operational.

16. The isolator sealing device according to claim 15, wherein said lip seal is rotationally coupled to said rotor.

17. The isolator sealing device according to claim 15, wherein said lip seal includes a lip capable of a sealing engagement when the piece of equipment is stationary and for disengagement at a low rotational speed.

18. The isolator sealing device according to claim 15, further comprising a shut-off valve located on an atmospheric side of said isolator sealing device, said shut-off valve sealingly engaging said stator or said rotor when the piece of equipment is idle and sealingly disengaging said stator or said rotor when the piece of equipment is operational.

19. The isolator sealing device according to claim 15, further comprising a stator deformable toroidal member for sealing between the housing of the piece of equipment and said stator.

20. The isolator sealing device according to claim 15, further comprising a deformable toroidal member sealing between the rotary shaft of the piece of equipment and said rotor.

21. The isolator sealing device according to claim 15, wherein said lip seal comprises a body portion abutting a radially inner surface of a longitudinal flange of said rotor.

22. The isolator sealing device according to claim 21, wherein said lip seal includes a lip extending radially inwardly from said body portion into engagement, when the piece of equipment is stationary, with a longitudinal flange of said stator.

23. The isolator sealing device according to claim 22, wherein said lip includes a first portion extending from said body portion of said lip seal toward said longitudinal flange of said stator, and a second portion extending from said first portion to a position between said longitudinal flange of said stator and said body portion.

24. The isolator sealing device according to claim 23, wherein said lip has a substantially V-shaped cross-section.

25. The isolator sealing device according to claim 23, wherein said second portion includes an enlarged end portion.

26. The isolator sealing device according to claim 22, wherein said lip is integral with, and made of a first material that is the same as that of a main part of said body portion, and an additional part that is formed of a second material that is denser than said first material.

27. The isolator sealing device according to claim 26, wherein said second material is a metal band.
